(19) United States
(12) Patent Application Publication
(10) Pub. No.: US 2015/0022810 A1
(43) Pub. Date: Jan. 22, 2015

(54) SPECTROPHOTOMETER AND IMAGE PARTIAL EXTRACTION DEVICE

(71) Applicant: Tomoari Kobayashi, Kyoto-shi (JP)

(72) Inventor: Tomoari Kobayashi, Kyoto-shi (JP)

(73) Assignee: SHIMADZU CORPORATION, Kyoto-shi, Kyoto (JP)

(21) Appl. No.: 14/375,192

(22) PCT Filed: Jan. 30, 2012
(86) PCT No.: PCT/JP2012/051945

§ 371 Date: Aug. 22, 2014

(51) Int. Cl. G01J 3/28

(52) U.S. Cl. CPC G01J 3/2823
USPC 356/319

(57) ABSTRACT

A spectrophotometer in which output ends of optical fibers are one-dimensionally arrayed in a z-axis direction on an output end face of a fiber box. That is to say, a two-dimensional area image of a display screen picked up through input ends arranged at 10×10 lattice points on an input end face of optical fibers is converted into a one-dimensional image inside the fiber box and projected from output ends on the output end face in the form of a one-dimensional area image parallel to the z-axis. This one-dimensional area image has position information of 100 measurement points in the z-axis direction.

### TECHNICAL FIELD

The present invention relates to a spectrophotometer and an image partial extraction device to be used in the spectrophotometer.

### BACKGROUND ART

Spectrophotometers for measuring a spectral intensity distribution within a two-dimensional area on a target object have been conventionally proposed. FIG. 3 is a configuration diagram of an optical system in a spectrophotometer described in Patent Literature 1.

A target object 32 is placed on a movable stage 31 which can be moved in the X-axis direction. A one-dimensional measurement area “A” (a linear area extending in the Y-axis direction) on the target object 32 is illuminated with light from a bar-shaped light source 33 mounted parallel to the plane of the target object 32. The light reflected on the surface of the target object 32 passes through a lens 34, whereby the light is focused on a slit plate 35 having a slit which is arranged parallel to the measurement area A and which is shorter than this area. After passing through the slit plate 35, the light forms a one-dimensional area image, which is projected on the diffracting surface of a concave diffraction grating 36 located above the slit plate 35. The diffraction grating 36 disperses the light into wavelength components distributed in the direction orthogonal to the one-dimensional area image, whereby a two-dimensional spectral image is formed. The light forming this two-dimensional spectral image is reflected by a concave reflector 37 and focused on the measurement surface of the photo detector 38. On the measurement surface of the photo detector 38, a large number of small photo-detection elements are two-dimensionally arrayed in such a manner that one direction (a-axis direction) of the array provides position information on the one-directional measurement area A in the Y-direction of the target object 32 while the (β-axis) direction orthogonal to the a axis provides spectrum information (spectral intensity information) at each micro area within the one-dimensional measurement area A.

By using such a system capable of obtaining a spectral intensity distribution on the one-dimensional measurement area A, it is possible to obtain a two-dimensional intensity distribution over a two-dimensional area on the target object 32 by repeatedly obtaining a spectral image of the one-dimensional measurement area while sequentially moving the movable stage 31 relative to the optical unit (which includes the light source 33 and other elements) in predetermined steps along the X axis.

Patent Literature 2 discloses another type of spectrophotometer, which measures the wavelength distribution of transmitted or reflected light at each of a plurality of measurement points, using the same number of high-speed spectrometers as the measurement points. The “spectrometer” in the present description is an optical unit having the functions of dispersing incident light into wavelength components and detecting the wavelength-dispersed light at each wavelength. The “high-speed spectrometer” is a spectrometer capable of simultaneously detecting the wavelength components of the dispersed light by a detector having the configuration of a line sensor.

### CITATION LIST

### Patent Literature

Patent Literature 1: JP 6-34525 A

Patent Literature 2: JP 2010-044001 A

### SUMMARY OF INVENTION

### Technical Problem

The spectrophotometer described in Patent Literature 1 requires a mechanism for sequentially moving the movable stage 31 relative to the optical unit. If there is a long distance to be covered by the relative movement, the moving mechanism needs to be accordingly large, which increases the entire size of the spectrophotometer. The period of time for the movement, which is required in addition to the period of time required for the spectral intensity measurement, will also be longer, which means a relative decrease in the measurement time. Other problems also arise, such as the dependency of the reproducibility of the measurement on the positioning accuracy or the possibility of damage to the movable parts in the moving mechanism.

The spectrophotometer described in Patent Literature 2 has the problem that, since a separate spectrometer is used for each measurement point, the device becomes expensive, and furthermore, the measurement is affected by a difference in the characteristics of the individual spectrometers.

The present invention has been developed to solve the previously described problems. Its primary objective is to provide a spectrophotometer which requires no moving mechanism for measuring a spectral intensity distribution on a predetermined area on a target object, and furthermore, which is inexpensive yet free from significant variations in the measurement performance among measurement points.

The secondary objective is to provide an image extraction device to be used in the aforementioned spectrophotometer.

### Solution to Problem

The spectrophotometer according to the present invention aimed at solving the previously described problems includes: an image-forming optical system for focusing light from a target object to form an image on a preset imaging plane;

a plurality of optical waveguides having input ends arranged at different positions on the imaging plane and output ends arrayed in a one-dimensional form;

a wavelength dispersion device for dispersing a one-dimensional area image formed by rays of light passing through the optical waveguides, into wavelength components distributed in a direction perpendicular to the one-dimensional area; and a photo detector for detecting, by means of a plurality of two-dimensionally arrayed photo-detection elements, a two-dimensional spectral image formed by the wavelength dispersion device.

The “one-dimension” in the present invention should preferably be a straight line but may have a slight curvature.

The arrangement of the input ends of the optical waveguides on the imaging plane may be one-dimensional or two-dimensional.

In the spectrophotometer according to the present invention, the positions of the input ends of the optical waveguides arranged on the imaging plane respectively correspond to the measurement points on the target object. The rays of light from the measurement points are picked up through the input ends into the optical waveguides and emitted from the one-dimensionally arrayed output ends of the same optical waveguides. Thus, the rays of light emitted from the measurement points in a one-dimensional or two-dimensional area on the target object are entirely converted into one-dimensionally arrayed emissions of light. These emissions of light are wavelength-dispersed by the wavelength dispersion device in the direction perpendicular to the array of the emitted light, whereby a two-dimensional spectral image is formed. Owing to such a configuration, a spectral intensity distribution over a one-dimensional or two-dimensional area on the target object can be obtained by a single measurement with the photo detector located in the next stage, where one direction of the spectral intensity distribution provides position information within the one-dimensional area on the target object or one-dimensional representation of the position within the two-dimensional area on the target object, while the direction perpendicular to the direction related to the position information provides spectral information of each measurement point on the target object. Furthermore, in the spectrophotometer according to the present invention, neither the wavelength dispersion device nor the photo detector is subdivided into smaller elements corresponding to the measurement points. That is to say, there is only one spectrometer unit having a wavelength dispersion device and a photo detector. Therefore, the present system can be inexpensively produced and yet is free from significant variations in the measurement performance among the measurement points.

Another aspect of the present invention is an image partial extraction device to be used in a spectrophotometer having: a wavelength dispersion device for dispersing light forming a one-dimensional area image into wavelength components distributed in a direction perpendicular to the one-dimensional area; and a photo detector for detecting, by means of a plurality of two-dimensionally arrayed photo-detection elements, a two-dimensional spectral image formed by the wavelength dispersion device, the image partial extraction device including:

an image-forming optical system for focusing light from a target object to form an image on a preset imaging plane; and

a plurality of optical waveguides having input ends arranged at different positions on the imaging plane and output ends arrayed in a one-dimensional form.

### ADVANTAGEOUS EFFECTS OF THE INVENTION

In the spectrophotometer according to the present invention, since a one-dimensional or two-dimensional area on the plane on which an image of the target object is formed is connected to the one-dimensional array consisting of the output ends directed to the wavelength dispersion device by a plurality of optical waveguides, a spectral intensity distribution on the one-dimensional or two-dimensional area on the target object can be obtained by a single measurement without moving the detection end relative to the target object. As a result, favorable effects are obtained, such as the shorter measurement time, higher measurement reproducibility, and longer service life due to the absence of moving parts that are prone to failure. Furthermore, since neither the wavelength dispersion device nor the photo detector is subdivided into smaller elements corresponding to the measurement points, the present system can be inexpensively produced and yet is free from significant variations in the measurement performance among the measurement points.

### BRIEF DESCRIPTION OF DRAWINGS

FIG. 1 is a schematic configuration diagram of a colorimeter as one embodiment of the spectrophotometer according to the present invention.

FIG. 2A is a plan view of the input end face of a fiber box used in the colorimeter of the present embodiment, FIG. 2B is a plan view of the output end face of the same fiber box, and FIG. 2C is a model diagram of a two-dimensional spectral image after the wavelength dispersion.

FIG. 3 is a schematic configuration diagram of a conventional example of the spectrophotometer.

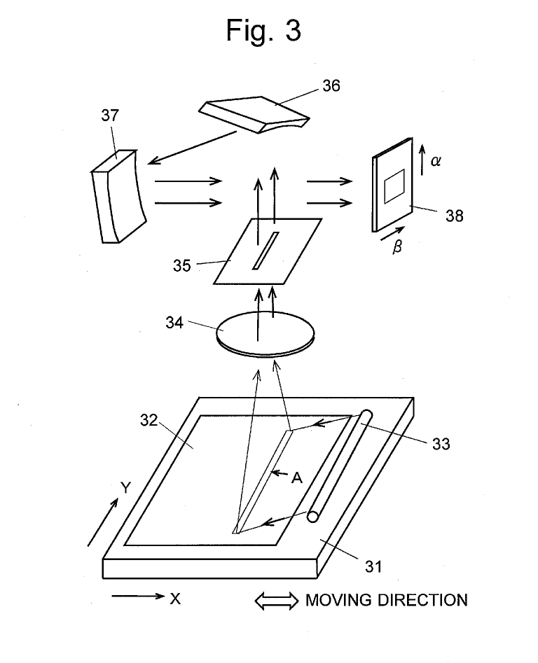

### DESCRIPTION OF EMBODIMENTS

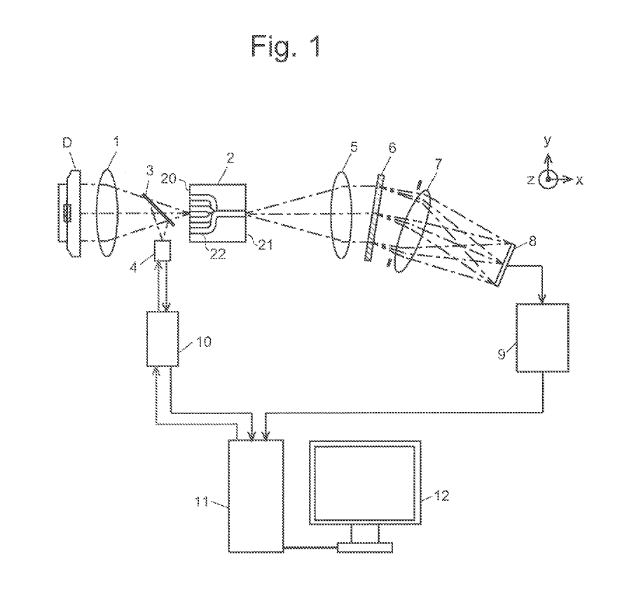

A colorimeter, which is one embodiment of the spectrophotometer according to the present invention, is hereinafter described with reference to FIG. 1. The colorimeter in FIG. 1 is designed for examining a display screen or similar target object for an unevenness in color or luminance. There are two kinds of methods for examining the evenness in color or luminance: the photoelectric tristimulus colorimetry and the spectrophotometric colorimetry. The colorimeter of the present embodiment uses the spectrophotometric colorimetry.

The colorimeter shown in FIG. 1 roughly consists of the following four sections: the image extraction system, the spectrometric detection system, as well as the controlling and data-processing system. The image extraction system includes an image taking lens 1, a fiber box 2, a polka-dot beam splitter 3 and a finder camera 4. The spectrometric detection system includes an incidence lens 5, a volume phase holographic grating (VPHG) 6, an exit lens 7 and a photo detector 8. The control and data-processing system includes a signal processor 9, a camera controller 10, a personal computer (PC) 11 and a display unit 12.

The image extraction system and the spectrometric detection system, both of which are the characteristic elements of the colorimeter of the present embodiment, are hereinafter described in detail.

### [Image Extraction System]

The image taking lens 1 is an element for forming an image of a two-dimensional area image of a display screen D (the target object) on the input end face 20 of the fiber box 2. That is to say, the image taking lens 1 and the fiber box 2 are arranged so that the focal plane of the image taking lens 1 coincides with the input end face 20 of the fiber box 2.

For ease of description, it is hereinafter assumed that the plane of paper of FIG. 1 is parallel to the xy-plane and the direction orthogonal to the plane of paper is the z-axis. Both the input and output end faces 20 and 21 are parallel to the yz-plane.

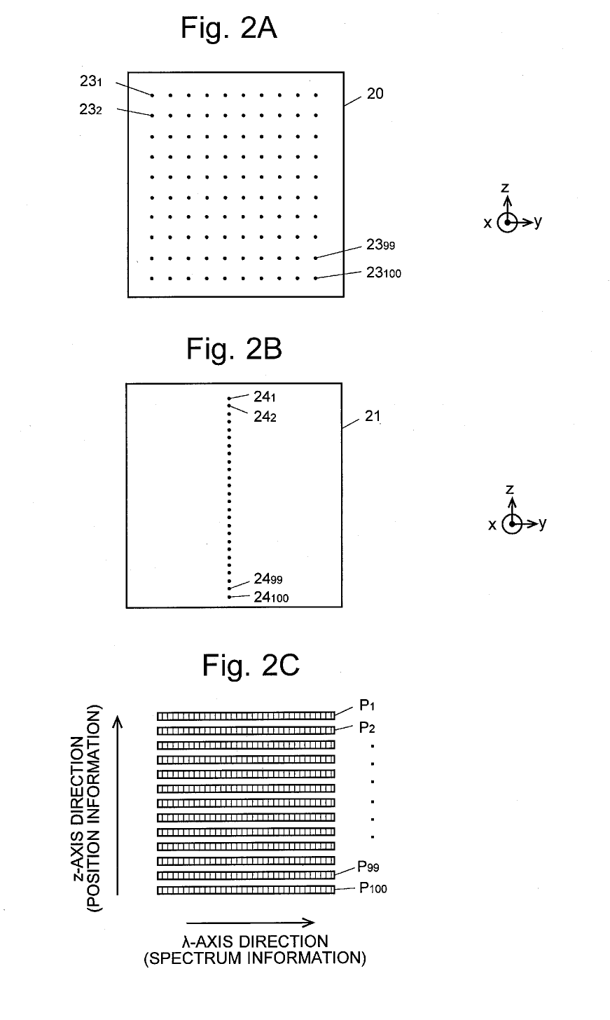

The fiber box 2 contains 100 optical fibers 22. As shown in FIG. 2A, the input ends 23 (numerals 23₁, . . . , 23₁₀₀ in FIG. 2A) of the optical fibers 22 are arrayed in a 10×10 matrix pattern on the input end face 20 of the fiber box 2. A two-dimensional area image of the display screen D is picked up through the input ends 23 and sent into the spectrometric detection system in the next stage, in which the image is dispersed into a spectral image and detected. As already stated, the input end face 20 of the fiber box 2 is placed on the plane on which the two-dimensional area image of the display screen D is formed. Accordingly, the positions of the input ends 23 of the optical fiber 2 correspond to the measurement points on the display screen D. The measurement points on the display screen D which correspond to the input ends 23₁, . . . , 23₁₀₀ are hereinafter respectively referred to as P₁, . . . , P₁₀₀, and the entire group of those measurement points is collectively called the measurement points P.

It should be noted that the input ends 23 do not need to be regularly arranged (as shown in FIG. 2A) but may be irregularly arranged. For example, they may be arranged densely in the central area and sparsely in the peripheral area.

On the output end face 21 of the fiber box 2, as shown in FIG. 21B, the 100 output ends 24 (24₁, . . . , 24₁₀₀ in FIG. 2B) of the optical fibers 22 are one-dimensionally arrayed in the z-axis direction. That is to say, the two-dimensional area image of the display screen D picked up through the input ends 23₁, . . . , 23₁₀₀ on the input end face 20 is converted into a one-dimensional image inside the fiber box 2 and projected from the output ends 24₁, . . . , 24₁₀₀ on the output end face 21 in the form of a one-dimensional area image extending in a direction parallel to the z-axis. Accordingly, this one-dimensional area image has position information of the measurement points from P₁ to P₁₀₀ in the z-axis direction.

In FIG. 1, the light which has passed through the image taking lens 1 is split into two beams by the polka-dot beam splitter 3, one of which is directed away from the fiber box 2 and forms an image on a plane, on which the imaging area of the finder camera 4 is located so that a two-dimensional area image of the display screen D can be taken with the finder camera 4. Providing such an image extraction system is not indispensable to the present invention but is preferable in that the positions of the input ends 23 relative to the two-dimensional area image of the display screen D (i.e. the positions of the measurement points P on the display screen D) can be checked in the controlling and data-processing system (which will be described later).

### [Spectrometric Detection System]

The incidence lens 5 is an element for collimating the rays of light (one-dimensional area image) emitted from the output ends 24 on the output end face 21 of the fiber box 2 so as to form a beam parallel to the x-axis and send it onto the VPHG 6.

The collimated rays of light forming the one-dimensional area image fall onto the VPHG 6 at a predetermined incidence angle. The VPHG 6 used in the present embodiment is arranged so as to disperse the one-dimensional area image into wavelength components in a direction perpendicular to the extending direction of the image (the z-axis direction), i.e. in a direction parallel to the xy-plane (this direction is hereinafter called the “X-axis direction”). That is to say, the rays of light forming the one-dimensional area image on the VPHG 6 are dispersed into wavelength components, without losing position information, while passing through the VPHG 6. The dispersed light forms a two-dimensional spectral image having position information in the z-axis direction and spectral information in the λ-axis direction (FIG. 2C). The light forming this two-dimensional spectral image is focused by the exit lens 7 and produces the image on the detection surface of the photo detector 8, to be detected by the plurality of photo-detection elements which are two-dimensionally arrayed on the detection surface.

The descriptions thus far have dealt with the image extraction system and the photometric detection system, which are the characteristic elements of the colorimeter of the present embodiment. The controlling and data-processing system is also hereinafter briefly described.

### [Controlling and Data-Processing System]

The output signals from the photo-detection elements of the photo detector 8 are subjected to predetermined kinds of signal processing, such as digitization and amplification in the signal processor 9, and sent to the PC 11, on which a dedicated controlling and data-processing program is installed. This program determines a two-dimensional spectral intensity distribution based on the outputs from the photo detector 8 and calculates the tristimulus values, chromaticity coordinates, color difference and various other color indices from the two-dimensional spectrometric intensity distribution according to the methods prescribed in the Japanese Industrial Standards (JIS). The result is presented on the screen of the display unit 12.

Furthermore, by sending predetermined control signals to the camera controller 10, the PC 11 can make the finder camera 4 capture an image via the camera controller 10 and obtain the captured image from the camera 4. The PC 11 can display, on the display unit 12, the relationship between the image data of the two-dimensional area image of the display screen D captured with the finder camera 4 and the input ends 23 of the optical fibers 22 on the input end face 20 which has been previously stored in a memory or similar device, thus allowing users to check the positions of the measurement points P on the display screen D. The PC 11 may also have the function of showing, on the display unit 12, the spectrum obtained at a measurement point selected from the measurement points P by a user using a pointing device or the like.

It is evident that the previously described embodiment of the spectrophotometer according to the present invention can be appropriately changed within the spirit of the present invention. For example, the transmission grating used as the wavelength dispersion device in the previous embodiment may be replaced with a reflection grating. The arrangement and/or number of optical fibers can also be appropriately changed as needed.

### REFERENCE SIGNS LIST

1 . . . Image Taking Lens
2 . . . Fiber Box
3 . . . Polka-Dot Beam Splitter
4 . . . Finder Camera
5 . . . Incidence Lens
6 . . . Volume Phase Holographic Grating (VPHG)
7 . . . Exit Lens
8 . . . Photo Detector
9 . . . Signal Processor
10 . . . Camera Controller
11 . . . Personal Computer (PC)
12 . . . Display Unit
20 . . . Input End Face
21 . . . Output End Face
22 . . . Optical Fiber
23, 23₁, 23₁₀₀ . . . Input End
24, 24₁, 24₁₀₀ . . . Output End
31 . . . Movable Stage
32 . . . Target Object
33 . . . Light Source
34 . . . Lens
35 . . . Slit Plate
36 . . . Concave Diffraction Grating
37 . . . Concave Reflector
38 . . . Photo Detector

1. A spectrophotometer, comprising:
an image-forming optical system for focusing light from a target object to form an image on a first imaging plane;
a beam splitter for splitting, into two beams, the light which has passed through the image-forming optical system;
a camera for taking an image of a second imaging plane on which one of the beams produced by the beam splitter forms an image;
a plurality of optical waveguides having input ends arranged at different positions on the first imaging plane and output ends arrayed in a one-dimensional form;
a wavelength dispersion device for dispersing a one-dimensional area image formed by rays of light exiting from the output ends of the optical waveguides, into wavelength components distributed in a direction perpendicular to the one-dimensional area; and
a photo detector for detecting, by means of a plurality of two-dimensionally arrayed photo-detection elements, a two-dimensional spectral image formed by the wavelength dispersion device.

2. The spectrophotometer according to claim 1, wherein the input ends are two-dimensionally arranged on the first imaging plane.

3. An image partial extraction device to be used in a spectrophotometer having: a wavelength dispersion device for dispersing rays of light respectively emitted from a plurality of points forming a one-dimensional area image into wavelength components distributed in a direction perpendicular to the one-dimensional area; and a photo detector for detecting, by means of a plurality of two-dimensionally arrayed photo-detection elements, a two-dimensional spectral image formed by the wavelength dispersion device, the image partial extraction device comprising:
an image-forming optical system for focusing light from a target object to form an image on a first imaging plane; and
a beam splitter for splitting, into two beams, the light which has passed through the image-forming optical system;
a camera for taking an image of a second imaging plane on which one of the beams produced by the beam splitter forms an image;
a plurality of optical waveguides having input ends arranged at different positions on the first imaging plane and output ends arrayed in a one-dimensional form.

4. The image partial extraction device according to claim 3, wherein the input ends are two-dimensionally arranged on the first imaging plane.

5. The spectrophotometer according to claim 2, wherein the input ends are arranged densely in a central area on the first imaging plane and sparsely in a peripheral area on the first imaging plane.

6. The image partial extraction device according to claim 4, wherein the input ends are arranged densely in a central area on the first imaging plane and sparsely in a peripheral area on the first imaging plane.
